(19) United States
(12) Patent Application Publication
(10) Pub. No.: US 2013/0258918 A1
(43) Pub. Date: Oct. 3, 2013

(54) METHOD OF COMMANDING WIRELESS DEVICES

(71) Applicant: Philip Andrew Rudland, Sunderland (GB)

(72) Inventor: Philip Andrew Rudland, Sunderland (GB)

(73) Assignee: KONINKLIJKE PHILIPS ELECTRONICS N.V., EINDHOVEN (NL)

(21) Appl. No.: 13/992,902

(22) PCT Filed: Nov. 25, 2011
(86) PCT No.: PCT/IB11/55306

§ 371 Date: Jun. 10, 2013

(30) Foreign Application Priority Data
Dec. 14, 2010 (EP) 10306406.9

(51) Int. Cl. H04L 29/06

(52) U.S. Cl. CPC H04L 29/06068
USPC 370/310

(57) ABSTRACT

A method of commanding a first wireless communicating device from a second wireless communicating device, comprising the following steps performed by a main portion of the second device: joining a wireless communication network to which the first communicating device is connected, using procedures of the protocol stack of the first device, thereby obtaining network information for constructing commands for the second device, and making the network information available for the remote control portion, and comprising the following steps performed by a remote control portion of the second device: retrieving the network information from the main portion of the second device, constructing a command message for the first device using a format of the command messages of the protocol stack of the first device and using the retrieved network information, and sending the command message to the first device, using the MAC and PHY layers.

### TECHNICAL FIELD

The present invention generally relates to interoperability of wireless communicating devices, in particular ZigBee devices.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section. Furthermore, all embodiments of the invention need not solve all (or even any) of the problems brought forward in this section.

The ZigBee Alliance defines the “ZigBee PRO stack” and the “ZigBee RF4CE stack” as wireless networking protocols running over the IEEE 802.15.4 MAC and PHY layers. The former is notably used for the home automation (HA) profile and commercial building automation (CBA) profile, and the latter for consumer electronic (CE) devices, such as a remote control (RC) controlling a television (TV).

The two stacks have incompatible command sets, both at the networking layers and the application layer, so devices implementing one generally cannot work with devices implementing the other.

It may be desirable that all ZigBee protocol stacks have some way of working together. For example it would be desirable that an RF4CE remote control to be able to turn on/off ZigBee PRO HA lights. Users sitting at home watching the TV may be pleased to have this functionality.

The two stacks are incompatible but are able to interwork because “ZigBee End Devices” (leaf nodes) from each are identical. A device can work on the other network by becoming a “ZigBee End Device”.

The ZigBee/ZigBee PRO stacks have various protocol layers:
Application profile (e.g. HA, or CBA),
ZigBee stack layers, including APS (Application Support Sublayer), NWK (network), etc. [there being a different NWK layer for ZigBee to that for ZigBee PRO],
IEEE 802.15.4 MAC,
IEEE 802.15.4 PHY (used at 2.4 GHz).

The ZigBee RF4CE stack has various protocol layers:
Application profile (e.g. CERC (Consumer Electronics Remote Control)),
RF4CE NWK layer (different again),
IEEE 802.15.4 MAC,
IEEE 802.15.4 PHY (used at 2.4 GHz).

The protocol interactions to control a ZigBee PRO HA light fall into two categories—commands for joining the device to the ZigBee PRO network (joining) and configuring it to talk to the right target(s) (binding), and the HA commands themselves used for turning on/off the lights (application commands).

A problem is that to implement the ZigBee PRO stack and HA profile is a complex task, and takes a lot of code space and RAM. It is desired to find a way to make an ultra-low resource mechanism by which, for example, an RF4CE remote control can control ZigBee PRO HA lights.

Hence, there is a need for providing some interoperability between ZigBee PRO and ZigBee RF4CE devices.

### SUMMARY

Therefore, a first aspect of the invention relates to a method of commanding a first wireless communicating device from a second wireless communicating device, wherein each of the first and second wireless communicating devices operate with respective networking protocol stacks comprising same MAC and PHY protocol layers and having different command sets. The second wireless communicating device has a main portion and a remote control portion, the method comprises the following steps performed by the main portion of the second wireless communicating device:

joining a wireless communication network to which the first communicating device is connected, using procedures of the protocol stack of the first wireless communicating device, thereby obtaining network information for constructing commands for the second wireless communicating device, and

making the network information available for the remote control portion,

the method further comprises the following steps performed by the remote control portion of the second wireless communicating device:

retrieving the network information from the main portion of the second wireless communicating device,

constructing a command message for the first wireless communicating device using a format of the command messages of the protocol stack of the first wireless communicating device and using the retrieved network information, and

sending the command message to the first wireless communicating device, using the MAC and PHY layers.

Thus, according to embodiments, the burden of implementation is split across more than one portion of the device. Specifically, the different implementation roles are split between the main portion and the remote control portion.

Hence, the remote control portion has an extremely small additional code space. Because it already has MAC and PHY layers, the additional software to send the command is small.

Also, the overhead added to the main portion is acceptable since memory requirements are likely to be less restrictive in this portion of the device.

For example, according to embodiments wherein the second device is a system comprising a TV set and a remote controller RC, the overhead added at the TV set should be less than a full ZigBee PRO+HA implementation, as there is no need for it to implement the HA profile, as that is done on the RC. Indeed in this way the TV set could work with further application profiles with no further modifications, as it wouldn't know or care what application profiles are implemented (or partially implemented) by the RC.

On the other hand, the TV set will need to store the ZigBee PRO network settings in a table somewhere, and then have these be sent to the RC at some point using the RF4CE stack and some suitable RF4CE application profile.

The two devices together could potentially achieve ZigBee PRO/HA certification, even though they are actually implemented on two radios, which can be physically separated.

Embodiments of the invention are recited in the dependent claims attached hereto.

A second aspect of the present invention relates to computer program products comprising one or more stored sequences of instructions that are accessible to a processor and which, when executed by the processor, cause the processor to carry out the steps of the method of the first aspect of the present invention.

A third aspect of the present invention relates to a system for implementing methods according to the first aspect of the invention.

### BRIEF DESCRIPTION OF THE DRAWINGS

The present invention is illustrated by way of example, and not by way of limitation, in the figures of the accompanying drawings, in which like reference numerals refer to similar elements and in which:

FIGS. 1-2 are schematic illustrations of a context of implementation of embodiments;

FIG. 3 is a flowchart illustrating steps of methods according to embodiments;

FIG. 4 is a schematic illustration of a system according to embodiments; and

FIG. 5 is a schematic illustration of a data structure for command messages according to embodiments.

### DESCRIPTION OF PREFERRED EMBODIMENTS

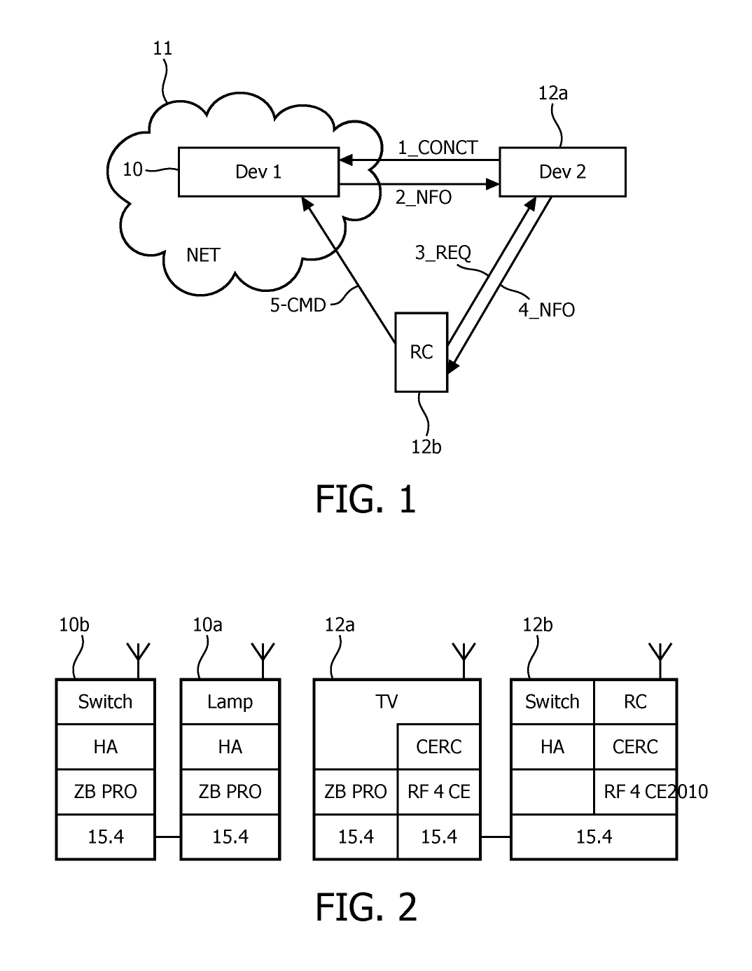

FIG. 1 illustrates a context of implementation of embodiments of the invention. A first device wireless communicating device 10 is part of a wireless communicating network 11. A second device has a main portion 12a and a remote control portion 12b. For example, the wireless communicating devices and the network operate according the ZigBee standard.

The first device operates according to a first protocol stack, for example the ZigBee PRO protocol stack. The second device operates according to another protocol stack, for example the ZigBee RF4CE protocol stack. The first and second protocol stack share same PHY and MAC protocol layers.

In order to enable the second device to command the first device, the additional mechanisms to support are shared between the main portion and the remote control portion of the second device.

Schematically, command process has the following structure:

1—the main portion connects to the network and binds to the first device,
2—the main portion receives networking information for use in the communications with the first device,
3—the remote control portion requests the networking information to the main portion,
4—the remote control portion constructs a command message based on the networking information, and
5—the remote control portion sends the command message to the first device.

With reference to FIG. 2, the splitting of the mechanisms is further explicated with an embodiment wherein the second device is a TV set 12a associated to a remote controller 12b and the first device is a lamp 10a associated to a switch 10b.

The lamp and the switch have ZigBee PRO stacks with a Home Automation (HA) profile, IEEE 802.15.4 MAC and IEEE 802.15.4 PHY (used at 2.4 GHz) layers.

The TV set has both ZigBee PRO and ZigBee RF4CE IEEE 802.15.4 MAC and IEEE 802.15.4 PHY (used at 2.4 GHz) layers and one CERC (Consumer Electronics Remote Control) application profile.

The remote controller which can also operate as a switch for the lamp has both HA and CERC application profiles but only has one ZigBee RF4CE IEEE 802.15.4 MAC and IEEE 802.15.4 PHY (used at 2.4 GHz) layers.

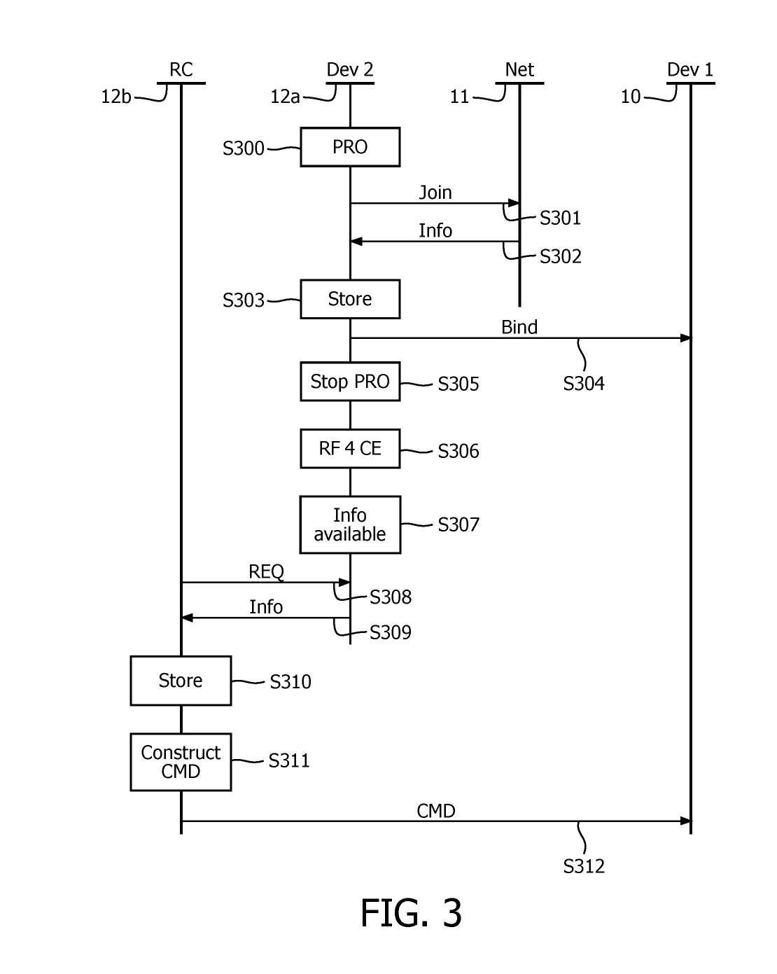

Steps to make an example implementation are described with reference to FIG. 3.

The main portion of the second device enters a ZigBee PRO mode in a step S300 and transmits a request for joining the ZigBee network 11 as described in the ZigBee PRO specifications during a step S301. For example, the request is sent on user demand (e.g.: button press/menu item select/etc).

Then, the main portion of the second device receives networking information (such as channel, network, device, group information) during step S302 and stores them during step S303 in a table.

The main portion of the second device then establishes a binding (S304) to the ZigBee PRO target device 10 or to groups of devices as described in the ZigBee PRO specifications, for example by involving the user (e.g.: button presses or by selecting the target from a menu, etc).

After that, during step S305, the main portion of the second device stops operating on the ZigBee PRO network (without necessarily sending a leave command).

It continues with starting operating as a ZigBee RF4CE device during step S306, as described in the RF4CE/Consumer Electronics Remote Control (CERC) specifications. Also, the main portion of the second device makes the networking information available to the remote control portion during step S307 by additionally supporting a mechanism (e.g.: simple profile) by which the remote controller portion can retrieve the stored networking information

The remote control portion operates as a ZigBee RF4CE RC device, as described in the RF4CE/Consumer Electronics Remote Control (CERC) specifications, additionally supporting a mechanism (e.g.: simple profile) by which it can retrieve networking information from a TV.

On request from the remote control portion in step S308, the main portion sends it during step S309 the stored channel/network/device/group/etc. networking information from the table. For example, the request is sent on user demand (e.g.: pressing a Configuration button) request the TV to send networking information.

On receipt of this information, the remote controller portion stores it in a table during step S310.

Then, during step S311, the remote control portion constructs a ZigBee PRO/HA profile command, for example, using a template [e.g.: predefined sequence of bytes] of a typical HA command (e.g.: On or Off). For example the command is constructed on user demand (e.g.: pressing an On or Off button for an On/Off command) The remote control portion replaces the network/device/group/etc. networking field values with values stored in the local table.

According to embodiments, the remote control portion keeps a record of all required counters (many layers have one or more counters), and increments them, and sets their updated values into the frame. It also performs any modifications required to the frame to operate correctly with these updated counter fields.

Back to FIG. 3, the remote control portion sets the channel to that stored in the table and sends the constructed frame to the first device using the 802.15.4 MAC and PHY layers during step S312. The remote control portion then returns to the normal operating channel.

In order to handle the changes of the networking information, the main portion of the second device may track these changes and report them to the remote controller portion. Alternatively, the remote controller portion may request poll for changes.

Information stored in the tables may include:
ZigBee PRO Personal Area Network's (PAN) operating channel (802.15.4 2.4 GHz channel numbers are in the range 10-26),
PAN ID (2 bytes, the ID of the PAN),
Short address that was allocated to the second device and which the remote controller portion will use (2 byte network address, allocated by the main portion's parent device on the ZigBee PRO PAN),
Short address of the parent device which the main portion joined (the parent's short address must be the MAC destination address of all frames sent by a ZED. The parent will see that the command is delivered to the NWK destination address),
Destination target address or a destination group address (binding target, the NWK destination address to which application commands are sent),
IEEE address of the main portion (8 bytes, persistent).

FIG. 5 illustrates a data structure for the command message. The command message comprises:

a MAC header that can store the PAN ID information received by the main portion of the second device,

a network (NWK) header that can store the short address allocated to the main portion,

an application (APS) header for storing the function supported,

a ZigBee cluster library (ZCL) header for defining the frame structure,

a ZigBee cluster library (ZCL) payload for storing the command ID (for example an ON/OFF command).

According to embodiments, the main portion keeps a record of counter values the remote control portion is using, and synchronises them from time to time. This might permit a second remote control portion to also send messages as if from the main portion, without running into difficulties with counter values being reused or going backwards.

One possibility would be that the main portion would attempt to join a ZigBee PRO network on request from a remote control portion, this request being received from the remote control portion using an RF4CE application command of some kind.

According to embodiments, the main portion of the second device joins the ZigBee PRO network using the IEEE address of the remote control portion. In such a case, the short address allocated to the remote control portion is unique to that remote control portion, and the main portion can join again on behalf of a second remote control portion and gets a different short address allocated, or the main portion can join the ZigBee PRO network itself and also implement one or more ZigBee PRO application profiles.

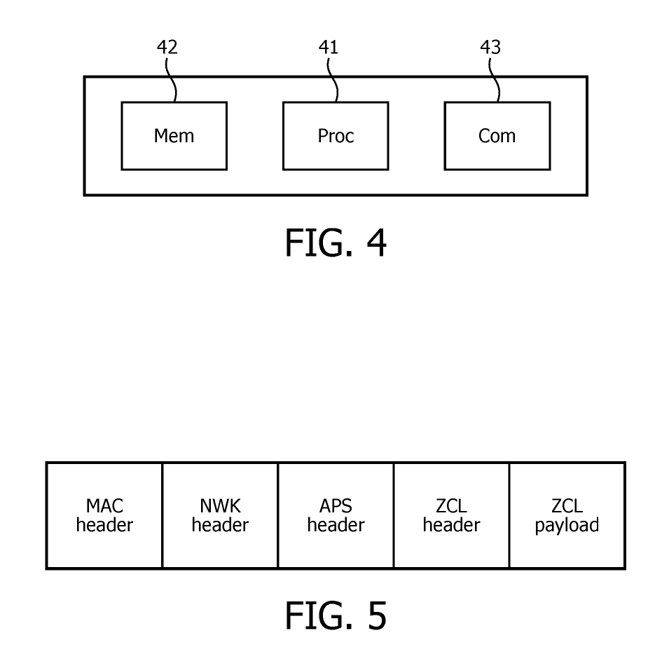

Referring to FIG. 4, a device according to embodiments is described. The device comprises a processing unit 41 configured for implementing methods according to embodiments of the invention. The device also comprises a memory unit 42. The memory unit may comprise several types of memory. For example, the memory unit may comprise a memory for storing processing data. The memory unit may also comprise a memory for storing a computer program according to embodiments of the invention. The device also comprises a communication unit 43 for performing communications with other communicating objects in order to command them.

Embodiments of the present invention can be embedded in a computer program product, which comprises all the features enabling the implementation of the methods described herein, and which—when loaded in an information processing system—is able to carry out these methods. Computer program means or computer program in the present context mean any expression, in any language, code or notation, of a set of instructions intended to cause a system having an information processing capability to perform a particular function either directly or after a conversion to another language. Such a computer program can be designed based on the flowchart of FIG. 3 and the present description. The computer program can be stored on a computer or machine readable medium allowing data, instructions, messages or message packets, and other machine readable information to be read from the medium. The computer or machine readable medium may include non-volatile memory, such as ROM, Flash memory, Disk drive memory, CD-ROM, and other permanent storage. Additionally, a computer or machine readable medium may include, for example, volatile storage such as RAM, buffers, cache memory, and network circuits. Furthermore, the computer or machine readable medium may comprise computer or machine readable information in a transitory state medium such as a network link and/or a network interface, including a wired network or a wireless network, that allow a device to read such computer or machine readable information.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

A person skilled in the art will readily appreciate that various parameters disclosed in the description may be modified and that various embodiments disclosed may be combined without departing from the scope of the invention.

1. A method of commanding a first wireless communicating device from a second wireless communicating device, each of said first and second wireless communicating devices operating with respective networking protocol stacks comprising same MAC and PHY protocol layers and having different command sets, and said second wireless communicating device having a main portion and a remote control portion, the method comprising the following steps performed by the main portion of the second wireless communicating device:
joining a wireless communication network to which the first communicating device is connected, using procedures of the protocol stack of the first wireless communicating device, thereby obtaining network information for constructing commands for the second wireless communicating device, and
making the network information available for the remote control portion,
the method further comprising the following steps performed by the remote control portion of the second wireless communicating device:
retrieving the network information from the main portion of the second wireless communicating device,
constructing a command message for the first wireless communicating device using a format of the command messages of the protocol stack of the first wireless communicating device and using the retrieved network information, and
sending the command message to the first wireless communicating device, using the MAC and PHY layers.

2. A method according to claim 1, wherein the first wireless communicating device operates with a ZigBee PRO stack and the second device operated with a ZigBee RF4CE stack.

3. A method according to claim 1, wherein the network information comprises at least one of:
an operating channel for transmitting the command message,
an identifier of the wireless communication network,
an address allocated on the network to the second wireless communicating device for use by the remote control portion for sending the command message, and
an address of the first wireless communicating device on the network for use by the remote control portion for sending the command message.

4. A method according to claim 1, wherein the network information is stored by the main portion of the second wireless communicating device for use for further command messages to be sent by the remote control portion of the second wireless communicating device.

5. A method according to claim 4, wherein the network information are updated by the main portion of the second wireless communicating device.

6. A method according to claim 5, wherein the remote control portion keeps a record of the updates in order to update the control messages sent over the network.

7. A method according to claim 1, wherein the main portion of the second wireless communicating device uses a hardware address of the remote control portion for communicating on the network.

8. A method according to claim 1, wherein the remote control portion constructs the command message using a template of a typical command message on the network, and fills the template using the retrieved network information.

9. A computer program product comprising a computer readable medium, having thereon a computer program comprising program instructions, the computer program being loadable into a data-processing unit and adapted to cause the data-processing unit to execute the steps of a method according to claim 1 when the computer program is run by the data-processing unit.

10. A system for commanding a first wireless communicating device from a second wireless communicating device, each of said first and second wireless communicating devices operating with respective networking protocol stacks comprising same MAC and PHY protocol layers and having different command sets, and said second wireless communicating device having a main portion and a remote control portion,
wherein the main portion of the second wireless communicating device is configured for:
joining a wireless communication network to which the first communicating device is connected, using procedures of the protocol stack of the first wireless communicating device, thereby obtaining network information for constructing commands for the second wireless communicating device, and
making the network information available for the remote control portion,
and wherein the remote control portion of the second wireless communicating device is configured for:
retrieving the network information from the main portion of the second wireless communicating device,
constructing a command message for the first wireless communicating device using a format of the command messages of the protocol stack of the first wireless communicating device and using the retrieved network information, and
sending the command message to the first wireless communicating device, using the MAC and PHY layers.

11. A system according to claim 11, wherein the second device comprises a television set as the main portion and a remote controller as the remote control portion.

12. A system according to claim 10, wherein the first device comprises a lamp that can be wirelessly commanded.

13. A system according to claim 10, wherein the first wireless communicating device operates with a ZigBee PRO stack and the second device operated with a ZigBee RF4CE stack.
